(19) United States
(12) Patent Application Publication
(10) Pub. No.: US 2019/0164036 A1
(43) Pub. Date: May 30, 2019

(54) METHOD AND APPARATUS FOR GENERATING ADDRESS OF DATA OF ARTIFICIAL NEURAL NETWORK

(71) Applicant: ELECTRONICS AND TELECOMMUNICATIONS RESEARCH INSTITUTE, Daejeon (KR)

(72) Inventors: Hyun Mi KIM, Daejeon (KR); Young-Su KWON, Daejeon (KR)

(73) Assignee: ELECTRONICS AND TELECOMMUNICATIONS RESEARCH INSTITUTE, Daejeon (KR)

(21) Appl. No.: 16/204,499

(22) Filed: Nov. 29, 2018

(30) Foreign Application Priority Data
Nov. 29, 2017 (KR) 10-2017-0162171
Nov. 28, 2018 (KR) 10-2018-0150077

(51) Int. Cl. G06N 3/04

(52) U.S. Cl. CPC G06N 3/04

(57) ABSTRACT

A method and an apparatus for generating an address of data for an artificial neural network through steps of: performing an N-dimensional loop operation for generating the address of the data based on predetermined parameters, and generating the address of the data in order according to a predetermined direction are provided.

### CROSS-REFERENCE TO RELATED APPLICATION

This application claims priority to and the benefit of Korean Patent Application Nos. 10-2017-0162171 and 10-2018-0150077 filed in the Korean Intellectual Property Office on Nov. 29, 2017 and Nov. 28, 2018, respectively, the entire contents of which are incorporated herein by reference.

### BACKGROUND OF THE INVENTION

### (a) Field of the Invention

The present disclosure relates to a method and apparatus for generating an address of data of an artificial neural network and an accelerator of an artificial neural network.

### (b) Description of the Related Art

Deep Neural Network (DNN) has recently been used in artificial intelligence. A Multilayer Perceptron (MLP), a Convolution Neural Network (CNN), and a Recurrent Neural Network are typical neural network technologies. DNN is composed of a plurality of layers, and each layer can be represented by a matrix or a vector operation. A dedicated hardware accelerator for efficiently processing a matrix or a vector operation is being developed because a matrix or vector operation requires a device having a high computing power.

### SUMMARY OF THE INVENTION

An exemplary embodiment provides a method for generating an address of data for an artificial neural network.

Another exemplary embodiment provides an apparatus for generating an address of data for an artificial neural network.

Yet another exemplary embodiment provides an accelerator including an address generating processor that generates an address of data for an artificial neural network

According to an exemplary embodiment, a method for generating an address of data for an artificial neural network is provided. The method includes: performing an N-dimensional loop operation based on a predetermined parameter to generate the address of the data; and generating the address of the data in order according to a predetermined direction, wherein the predetermined parameter includes an address value of first data in a memory of the artificial neural network, a repetition number of each loop of the N-dimensional loop operation, and an address offset of each loop of the N-dimensional loop operation.

The method may further include sequentially inputting the data having the generated address as an operand of a computation processor of the artificial neural network when the data is input data of the artificial neural network.

The method may further include storing the data output from a computation processor of the artificial neural network at the generated address when the data is output data of the artificial neural network.

The method may further include sequentially inputting the data having the generated address as an operand of a computation processor of the artificial neural network when the data is kernel data of the artificial neural network.

The predetermined parameter may be pre-determined based on at least one of a size of kernel data to be input to a computation processor of the artificial neural network, a size of feature map data to be input to the computation processor, a size of pooling operation, and stride value.

The predetermined direction may be a sequence of a kernel direction, a channel direction, a pulling direction, and a sliding window direction.

The number of the predetermined parameters may be 2N+1.

According to another exemplary embodiment, an apparatus for generating an address of data for an artificial neural network is provided. The apparatus includes a processor, a memory, and an interface, wherein the processor executes a program stored in the memory to perform: performing an N-dimensional loop operation based on a predetermined parameter to generate the address of the data; and generating the address of the data in order according to a predetermined direction, wherein the predetermined parameter includes an address value of first data in a memory of the artificial neural network, a repetition number of each loop of the N-dimensional loop operation, and an address offset of each loop of the N-dimensional loop operation.

The processor may execute the program to further perform sequentially inputting the data having the generated address through the interface as an operand of a computation processor of the artificial neural network when the data is input data of the artificial neural network.

The processor may execute the program to further perform storing data output from a computation processor of the artificial neural network at the generated address through the interface when the data is output data of the artificial neural network.

The processor may execute the program to further perform sequentially inputting the data having the generated address through the interface as an operand of a computation processor of the artificial neural network when the data is kernel data of the artificial neural network.

The predetermined parameter may be pre-determined based on at least one of a size of kernel data to be input to a computation processor of the artificial neural network, a size of feature map data to be input to the computation processor, a size of pooling operation, and stride value.

The predetermined direction may be a sequence of a kernel direction, a channel direction, a pulling direction, and a sliding window direction.

The number of the predetermined parameters may be 2N+1.

According to yet another exemplary embodiment, an accelerator of an artificial neural network is provided. The accelerator includes an address generating processor, an computation processor, and a memory, wherein the address generating processor executes a program stored in the memory, performing an N-dimensional loop operation based on a predetermined parameter to generate the address of data to be processed by the accelerator; and generating the address of the data in order according to a predetermined direction, wherein the predetermined parameter includes an address value of first data in the memory, a repetition number of each loop of the N-dimensional loop operation, and an address offset of each loop of the N-dimensional loop operation, and is pre-determined based on at least one of a size of kernel data stored in the memory, a size of feature map data stored in the memory, a size of pooling operation, and stride value.

The address generating processor may execute the program to further perform sequentially inputting the data having the generated address to the computation processor as an operand when the data is input data of the artificial neural network.

The address generating processor may execute the program to further perform storing the data output from the computation processor in the memory according to the generated address when the data is output data of the artificial neural network.

The address generating processor may execute the program to further perform sequentially inputting the data having the generated address to the computation processor as an operand when the data is kernel data of the artificial neural network.

The predetermined direction may be a sequence of a kernel direction, a channel direction, a pulling direction, and a sliding window direction.

The number of the predetermined parameters may be 2N+1.

### BRIEF DESCRIPTION OF THE DRAWINGS

FIG. 1 is a block diagram illustrating dedicated hardware device for processing a matrix operation of a layer of a DNN according to an exemplary embodiment.

FIG. 2 is a block diagram illustrating an accelerator according to an exemplary embodiment.

FIG. 3 is a conceptual diagram illustrating an operation performed on a kernel in a layer of an artificial neural network according to an exemplary embodiment.

FIG. 4 is a pseudo code illustrating an address generating apparatus according to an exemplary embodiment.

FIG. 5 is a flowchart illustrating an address generating method according to an exemplary embodiment.

FIG. 6 is a block diagram illustrating a computer system for implementing an accelerator according to an exemplary embodiment.

### DETAILED DESCRIPTION OF THE EMBODIMENTS

Hereinafter, exemplary embodiments of the present disclosure will be described in detail with reference to the accompanying drawings so that those skilled in the art may easily practice the present disclosure. However, the present disclosure may be modified in various different ways and is not limited to embodiments described herein. In the accompanying drawings, portions unrelated to the description will be omitted in order to obviously describe the present disclosure, and similar reference numerals will be used to describe similar portions throughout the present specification.

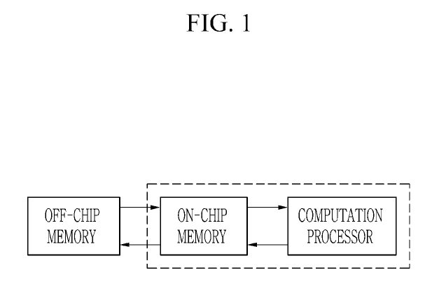

FIG. 1 is a block diagram illustrating dedicated hardware device for processing a matrix operation of a layer of a DNN according to an exemplary embodiment.

Referring to FIG. 1, an accelerator for processing an operation of each layer includes a Matrix/Vector computation unit (or a computation processor) and a memory. The computation processor may perform various operations including matrix operation or vector operation. The memory may store input data that is needed for performing an operation in the computation processor and store output data that is a result of the operation of the computation processor. The memory may include an on-chip memory within the chip and an off-chip memory outside the chip. The on-chip memory is a memory for quick access to the memory, and the off-chip memory is a memory for storing a large amount of data.

The off-chip memory is a mass storage device. For example, the off-chip memory includes a dynamic random access memory (DRAM) or the like. It may be used for sharing data with hardware other than the hardware accelerator of the artificial neural network and may also be used for temporarily storing data when the capacity of the on-chip memory is insufficient. The on-chip memory may include a static random access memory (SRAM) or the like. The on-chip memory may quickly supply data to the computation processor and may quickly store the computation results of the computation processor.

Generally, all or some of the data stored in the off-chip memory is transferred to the on-chip memory for the operation. Then, the data transferred to the on-chip memory may be sequentially supplied to the computation processor at every clock. The output data of the computation processor may also be sequentially stored in the on-chip memory at every clock. The output data stored in the on-chip memory may be reused for the next operation depending on the situation, shared with other hardware, or moved to off-chip memory for later re-use.

In order for the input data to be sequentially transferred from the on-chip memory to the computation processor and the output data of the computation processor to be stored in a predetermined location of the on-chip memory for each of the clocks for the matrix operation or the vector operation, it is necessary that the data is sequentially stored in the memory. However, the data rearrangement operation, which is performed additionally to sequentially store the data, lowers the processing speed of the entire accelerator and degrades the performance. Also, since the data to be reused later is stored in the memory several times in accordance with the reuse order, a large memory space is required, and the cost of the accelerator is increased due to the increase of the size of the accelerator. Specifically in the artificial neural network, which has a lot of reusable data like CNN, the problem is serious.

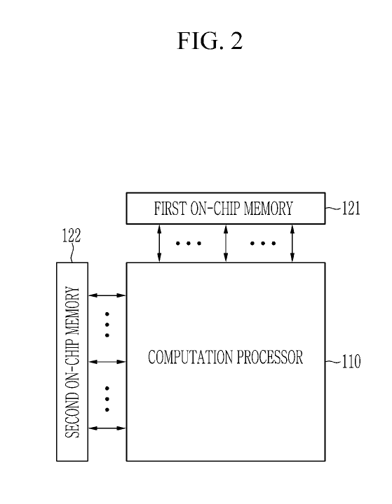

FIG. 2 is a block diagram illustrating an accelerator according to an exemplary embodiment.

Referring to FIG. 2, an accelerator 100 according to an exemplary embodiment includes a computation processor 110, a first on-chip memory 121, and a second on-chip memory 122. The accelerator 100 according to the exemplary embodiment may be used in CNN, MLP, recurrent neural network (RNN), and the like. In the CNN, the computation processor 110 may be a Multiply and Accumulator (MAC).

In FIG. 2, the first on-chip memory 121 and the second on-chip memory 122 may supply two operands to the computation processor 110, respectively. For example, in CNN, the two operators supplied by each on-chip memory may be feature map data and kernel data. The operation result of the operands in the computation processor 110 is temporarily stored in a register in the computation processor 110 during accumulation and then stored in the first on-chip memory 121 or the second on-chip memory 122.

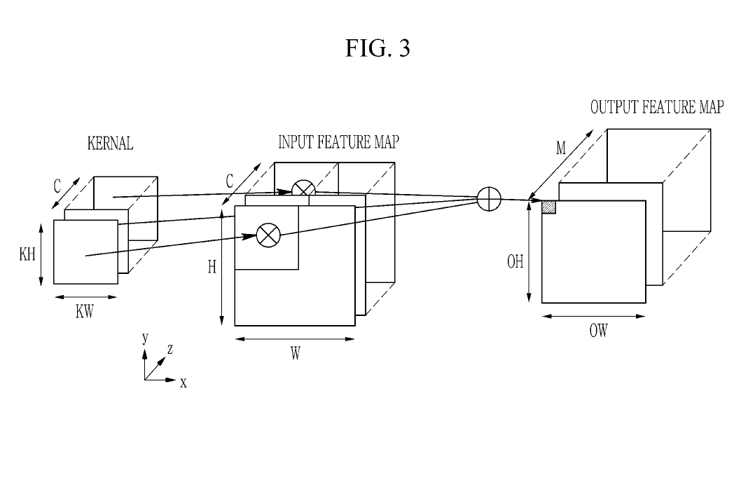

FIG. 3 is a conceptual diagram illustrating an operation performed on a kernel in a layer of an artificial neural network according to an exemplary embodiment.

Referring to FIG. 3, a size of a 3-dimensional kernel data is KW×KH×C. One of the three-dimensional kernel data sequentially scans the input feature map in the x direction and the y direction, performs a convolution operation with the feature map data according to the scanning directions, and generates a channel of M channels (z direction) in the output feature map. As a result, the M kernel data may generate an output feature map of the M channel through convolution operation performed by each kernel. Scaling, bias, batch normalization, activation, and pooling operations may then optionally be applied to the result of the result of the convolution operation. Equation 1 below is a formulization of FIG. 3.

$$Output [ n ] [ m ] [ l ] = ACT ( BatchNorm ( Bias + Scale \times {{\sum }_{k = 0}}^{C - 1} {{\sum }_{j = 0}}^{KH - 1} {{\sum }_{i = 0}}^{KW - 1} Inpupt [ k ] [ m + j ] [ l + i ] \times Kernel [ n ] [ k ] [ j ] [ i ] ) ) \\ ( 0 \leq l < W , 0 \leq m < H , 0 \leq n < M ) \qquad [ Equation 1 ]$$

In Equation 1, ACT indicates an activation operation, BatchNorm. Indicates a batch normalization, and the pooling operation is omitted. The order of each index in Equation 1 may be changed and different indexes are required for the input, the kernel, and the output, respectively. Since the input data, the kernel data, and the output data in the accelerator of FIG. 2 are located on the memory, the index of the input, kernel, and output of Equation 1 may be calculated as address values on the memory.

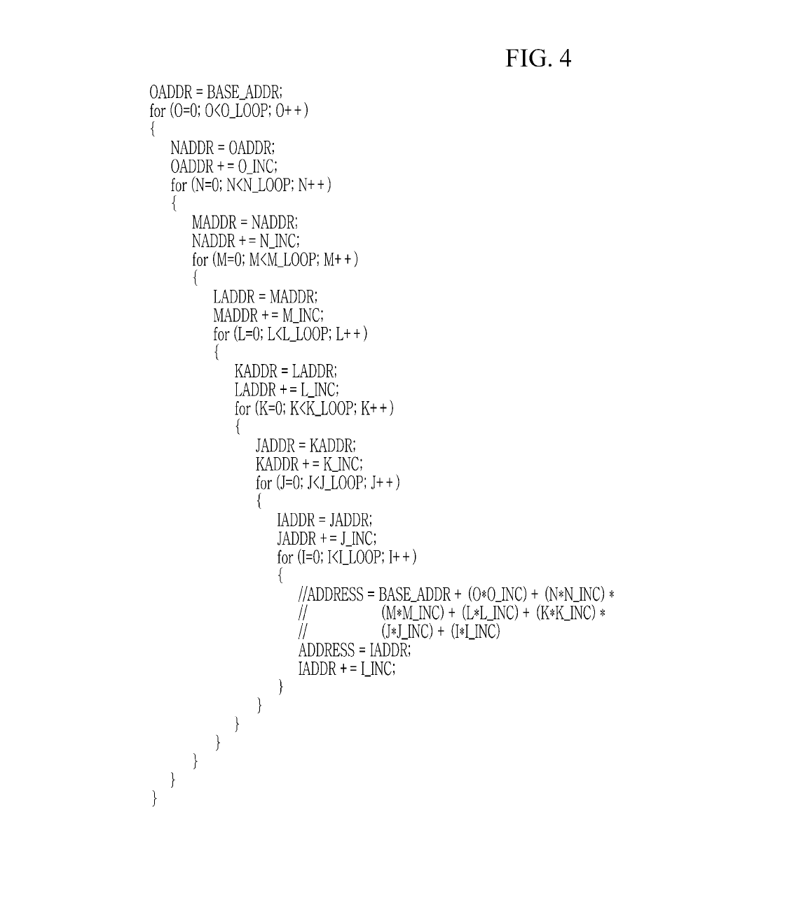

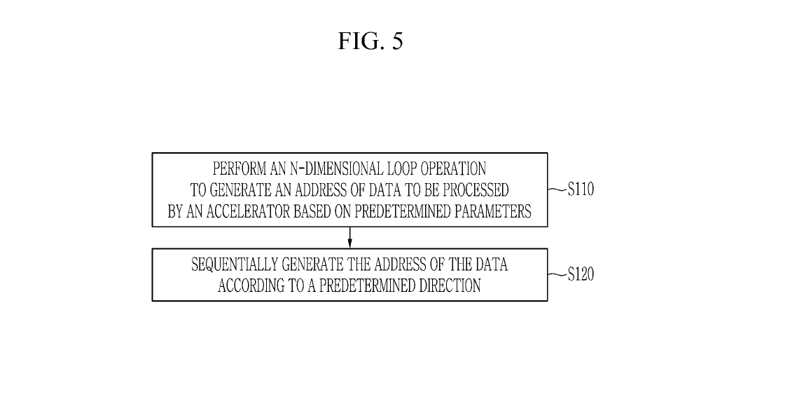

FIG. 4 is a pseudo code illustrating an address generating apparatus according to an exemplary embodiment, and FIG. 5 is a flowchart illustrating an address generating method according to an exemplary embodiment.

In an artificial neural network, the address values of the input data, the kernel data, and the output data are very fluid and may be affected by various parameters. For example, in the CNN of FIG. 3, the address value of each data may be influenced by KW, KH, C, W, H, and M values, size of pooling, stride value and the like. In the exemplary embodiment, a programmable address generator (or address generating processor), which may be applied to various artificial neural networks or layers of each artificial neural network, may be implemented by an N-dimensional loop operator. In this case, the N is a natural number and may be determined according to the specification of a hardware accelerator including the address generator according to the exemplary embodiment.

Referring to FIG. 5, when three predetermined types of parameters are input to the N-dimensional loop operator, an address generating apparatus according to an exemplary embodiment performs N-dimensional loop operation based on a predetermined parameter to generate an address of data to be processed by the accelerator (S110). The three types of parameters input to the address generator of FIG. 4 are as follows.

1. Address value of the first data in memory (base address)

2. Repetition number of each loop (X_LOOP)

3. Address offset of each loop (X_INC)

In the exemplary embodiment, the number of parameters classified into three types is 2N+1 in the N-dimensional loop operation. Referring to FIG. 4, for the 7-dimensional loop operation, 15 parameter registers (1 base address+7 X_LOOP+7 X_INC) are preset by a host processor or the like. When 15 parameters are input to the address generating apparatus, address values (‘ADDRESS’ in FIG. 4) of the input data, the kernel data, or the output data may be generated according to the preset parameters.

For example, in order to generate the addresses of the input feature map data for the CNN of FIG. 3, 15 parameters may be set in advance as shown in Equation 2 below. In Equation 2, P represents the size of the pooling, and S represents the stride value. Referring to FIG. 3, KW is the size of the kernel data in the x direction, KH is the size of the kernel data in the y direction, C is the size of the kernel data in the channel direction, W is the size of the input feature map in the x Direction, and H is the size of the input feature map in the y direction. That is, the parameters input to the address generating apparatus according to the exemplary embodiment are pre-determined based on at least one of the size of the kernel data, the size of the input feature map data, the size of the pooling, the stride value, and the size of the channel of the output feature map data.

BASE_ADDRESS=0

I_LOOP=KW, I_INC=1

J_LOOP=KH, J_INC=W

K_LOOP=C, K_INC=W×H

L_LOOP=P, L_INC=S

M_LOOP=P, M_INC=W×S

N_LOOP=W/(P×S), N_INC=P×S

O_LOOP=H/(P×S), O_INC=W×P×S [Equation 2]

When three kinds of 15 parameters such as Equation 2 are input to the address generating apparatus according to the exemplary embodiment, the address generating apparatus sequentially generates the addresses of data according to the predetermined direction (S120). According to the exemplary embodiment, the predetermined direction in which the address of the data is generated may be a sequence of a kernel direction, a channel direction, a pulling direction, and a sliding window direction. Referring to FIG. 3, the address of the input feature map data may be generated in order according to a sequence of [Kernel X direction->Kernel Y direction->Channel direction->Pooling X direction->Pooling Y direction->Sliding window X direction->Sliding window Y direction], and the data having the generated address are sequentially inputted to the computation processor 110 as operands.

Alternatively, a parameter for generating the address of the output data is input to the address generating device, the output data output from the computation processor 110 of the artificial neural network is stored at the address generated by the address generating device. In other case, a parameter for generating the address of the kernel data is input to the address generating device, the data having the address generated by the address generating device are sequentially inputted to the computation processor 110 as the operand.

As described above, by using the address generating apparatus according to the exemplary embodiment, an additional operation for rearranging the data in the memory in order is unnecessary and the processing speed of the accelerator may be increased. In addition, when the address of the data is generated using the address generating device, it is not necessary to copy the redundant data to another address in the memory, thereby minimizing the memory use. Further, when the address generating device according to the exemplary embodiment is also used for data movement in the on-chip memory, data transactions between the off-chip memory and the on-chip memory can be minimized.

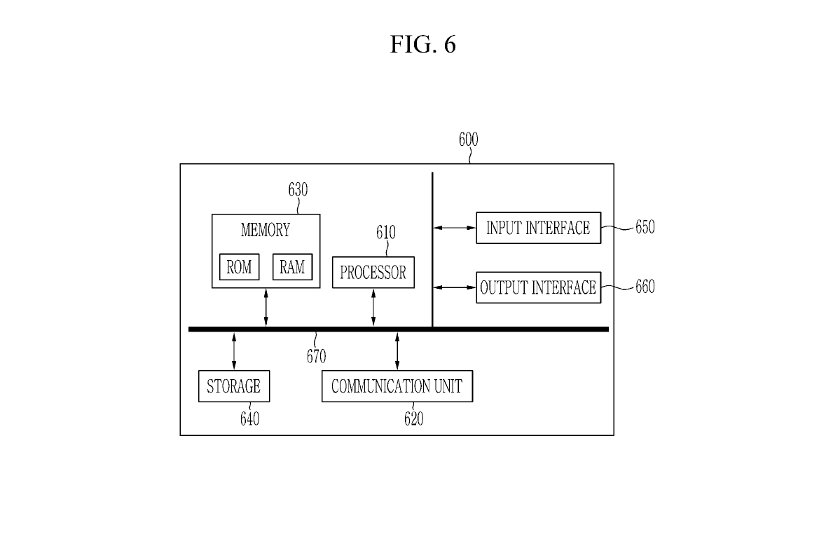

FIG. 6 is a block diagram illustrating a computer system for implementing an accelerator according to an exemplary embodiment.

The neural network according to an exemplary embodiment may be implemented as a computer system, for example a computer readable medium. Referring to FIG. 6, a computer system 600 may include at least one of processor 610, a memory 630, an input interface 650, an output interface 660, and storage 640. The computer system 600 may also include a communication device 620 coupled to a network. The processor 610 may be a central processing unit (CPU) or a semiconductor device that executes instructions stored in the memory 630 or storage 640. The memory 630 and the storage 640 may include various forms of volatile or non-volatile storage media. For example, the memory may include read only memory (ROM) or random access memory (RAM). In the exemplary embodiment of the present disclosure, the memory may be located inside or outside the processor, and the memory may be coupled to the processor through various means already known.

Thus, embodiments of the present invention may be embodied as a computer-implemented method or as a non-volatile computer-readable medium having computer-executable instructions stored thereon. In the exemplary embodiment, when executed by a processor, the computer-readable instructions may perform the method according to at least one aspect of the present disclosure. The communication device 620 may transmit or receive a wired signal or a wireless signal.

On the contrary, the embodiments of the present invention are not implemented only by the apparatuses and/or methods described so far, but may be implemented through a program realizing the function corresponding to the configuration of the embodiment of the present disclosure or a recording medium on which the program is recorded. Such an embodiment can be easily implemented by those skilled in the art from the description of the embodiments described above. Specifically, methods (e.g., network management methods, data transmission methods, transmission schedule generation methods, etc.) according to embodiments of the present disclosure may be implemented in the form of program instructions that may be executed through various computer means, and be recorded in the computer-readable medium. The computer-readable medium may include program instructions, data files, data structures, and the like, alone or in combination. The program instructions to be recorded on the computer-readable medium may be those specially designed or constructed for the embodiments of the present disclosure or may be known and available to those of ordinary skill in the computer software arts. The computer-readable recording medium may include a hardware device configured to store and execute program instructions. For example, the computer-readable recording medium can be any type of storage media such as magnetic media like hard disks, floppy disks, and magnetic tapes, optical media like CD-ROMs, DVDs, magneto-optical media like floptical disks, and ROM, RAM, flash memory, and the like. Program instructions may include machine language code such as those produced by a compiler, as well as high-level language code that may be executed by a computer via an interpreter, or the like.

While this invention has been described in connection with what is presently considered to be practical example embodiments, it is to be understood that the invention is not limited to the disclosed embodiments, but, on the contrary, is intended to cover various modifications and equivalent arrangements included within the spirit and scope of the appended claims.

What is claimed is:

1. A method for generating an address of data for an artificial neural network, comprising:
performing an N-dimensional loop operation based on a predetermined parameter to generate the address of the data; and
generating the address of the data in order according to a predetermined direction,
wherein the predetermined parameter includes an address value of first data in a memory of the artificial neural network, a repetition number of each loop of the N-dimensional loop operation, and an address offset of each loop of the N-dimensional loop operation.

2. The method of claim 1, further comprising
sequentially inputting the data having the generated address as an operand of a computation processor of the artificial neural network when the data is input data of the artificial neural network.

3. The method of claim 1, further comprising
storing the data output from a computation processor of the artificial neural network at the generated address when the data is output data of the artificial neural network.

4. The method of claim 1, further comprising
sequentially inputting the data having the generated address as an operand of a computation processor of the artificial neural network when the data is kernel data of the artificial neural network.

5. The method of claim 1, wherein the predetermined parameter is pre-determined based on at least one of a size of kernel data to be input to a computation processor of the artificial neural network, a size of feature map data to be input to the computation processor, a size of pooling operation, and stride value.

6. The method of claim 1, wherein the predetermined direction is a sequence of a kernel direction, a channel direction, a pulling direction, and a sliding window direction.

7. The method of claim 1, wherein a number of the predetermined parameters is 2N+1.

8. An apparatus for generating an address of data for an artificial neural network,
a processor, a memory, and an interface, wherein the processor executes a program stored in the memory to perform:
performing an N-dimensional loop operation based on a predetermined parameter to generate the address of the data; and
generating the address of the data in order according to a predetermined direction,
wherein the predetermined parameter includes an address value of first data in a memory of the artificial neural network, a repetition number of each loop of the N-dimensional loop operation, and an address offset of each loop of the N-dimensional loop operation.

9. The apparatus of claim 8, wherein the processor executes the program to further perform
sequentially inputting the data having the generated address through the interface as an operand of a computation processor of the artificial neural network when the data is input data of the artificial neural network.

10. The apparatus of claim 8, wherein the processor executes the program to further perform
storing data output from a computation processor of the artificial neural network at the generated address through the interface when the data is output data of the artificial neural network.

11. The apparatus of claim 8, wherein the processor executes the program to further perform
sequentially inputting the data having the generated address through the interface as an operand of a computation processor of the artificial neural network when the data is kernel data of the artificial neural network.

12. The apparatus of claim 8, wherein the predetermined parameter is pre-determined based on at least one of a size of kernel data to be input to a computation processor of the artificial neural network, a size of feature map data to be input to the computation processor, a size of pooling operation, and stride value.

13. The apparatus of claim 8, wherein the predetermined direction is a sequence of a kernel direction, a channel direction, a pulling direction, and a sliding window direction.

14. The method of claim 8, wherein a number of the predetermined parameters is 2N+1.

15. An accelerator of an artificial neural network,
an address generating processor, a computation processor, and a memory, wherein the address generating processor executes a program stored in the memory,
performing an N-dimensional loop operation based on a predetermined parameter to generate the address of data to be processed by the accelerator; and
generating the address of the data in order according to a predetermined direction,
wherein the predetermined parameter includes an address value of first data in the memory, a repetition number of each loop of the N-dimensional loop operation, and an address offset of each loop of the N-dimensional loop operation, and is pre-determined based on at least one of a size of kernel data stored in the memory, a size of feature map data stored in the memory, a size of pooling operation, and stride value.

16. The accelerator of claim 15,
wherein the address generating processor executes the program to further perform
sequentially inputting the data having the generated address to the computation processor as an operand when the data is input data of the artificial neural network.

17. The accelerator of claim 15,
wherein the address generating processor executes the program to further perform
storing the data output from the computation processor in the memory according to the generated address when the data is output data of the artificial neural network.

18. The accelerator of claim 15,
wherein the address generating processor executes the program to further perform
sequentially inputting the data having the generated address to the computation processor as an operand when the data is kernel data of the artificial neural network.

19. The accelerator of claim 15, wherein the predetermined direction is a sequence of a kernel direction, a channel direction, a pulling direction, and a sliding window direction.

20. The accelerator of claim 15, wherein a number of the predetermined parameters is 2N+1.
